(19) United States
(12) Patent Application Publication
(10) Pub. No.: US 2002/0081189 A1
(43) Pub. Date: Jun. 27, 2002

(54) Star wheel for glass container inspection machine

(76) Inventor: Stephen M. Giometti, Horseheads, NY (US)

Correspondence Address: Spencer T. Smith, Emhart Glass Manufacturing Inc., 89 Phoenix Avenue, P O Box 1229, Enfield, CT, 06083-1229, US

(21) Appl. No.: 09/746,251

(22) Filed: Dec. 21, 2000

(51) Int. Cl. B65G 47/26

(52) U.S. Cl. 414/791.2

(57) ABSTRACT

A glass container inspecting machine which has a star wheel carrier assembly which includes a vertical rotatable shaft and upper and lower hub assemblies mounted on the shaft. Each assembly has a central hub portion which is secured on the shaft and an annular outer supporting portion. Three identical carrier segments, arranged in side by side relation to form an annular carrier are secured to the annular outer supporting portion. Each segment has a plurality of bottle receiving pockets and a partial pocket at either end which, with a partial pocket of an adjacent segment forms a complete bottle receiving pocket.

The present invention relates to glass container inspection machines and more particularly to star wheel conveyors used in such machines.

### BACKGROUND OF THE INVENTION

A conventional way of inspecting bottles which are being carried along a linear conveyor is to utilize a star wheel conveyor to remove the bottles from the linear conveyor, displace the bottles through a number of inspection stations, and than redeliver the inspected bottles to the linear conveyor.

Conventional star wheel feeders (conveyors) are made up of upper and lower spaced wheels that are specifically machined to match a given bottle. Around the periphery of the upper wheel are cutouts configured for receiving the neck or body portion of this given bottle and around the periphery of the lower wheel are cutouts configured for receiving the body portion of this given bottle. Each wheel may have two semi-circular portions, which together define an inner hole, so that the semi circular portions can be releasably clamped to a central rotatable support shaft. The number of pockets in a starwheel may vary. In one specific example, two sets of star wheel pairs are generally used with one pair designed to have nine bottle receiving pockets for handling large bottles and one pair designed to have eighteen bottle receiving pockets for handling small bottles.

An undesirable consequence of this design is that one pocket of the nine pocket star wheel pair will not be defined symmetrically by a pocket portion on each of the adjacent semi-circular portions. The entire pocket on one end of a semi-circular star wheel portion adjacent to the other semi-circular star wheel portion will be defined in only one of the semi-circular star wheel portions. It has been discovered that this pocket can not stabilize the contained bottle to the same extent as the other pockets.

### OBJECT OF THE INVENTION

It is accordingly an object of the present invention to provide a glass container inspection machine having a star wheel feeder where all the supported bottles will have equal stability.

Other objects and advantages of the present invention will become apparent from the following portion of this specification and from the accompanying drawings, which illustrate in accordance with the mandate of the patent statutes a presently preferred embodiment incorporating the principles of the invention.

### BRIEF DESCRIPTION OF THE DRAWINGS

FIG. 1 is a top schematic view of a glass container inspection machine, which has a star wheel feeder;

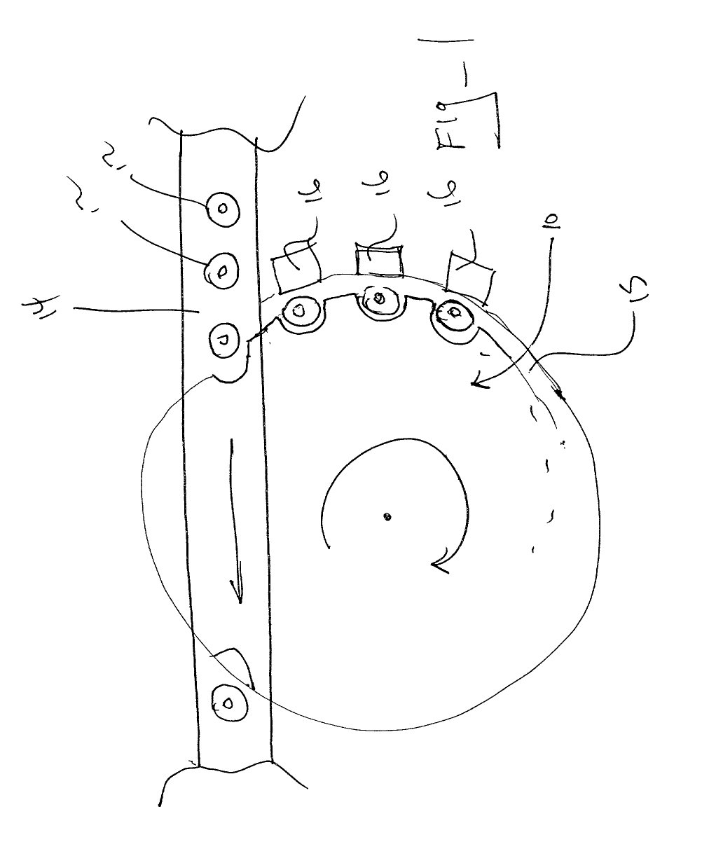

FIG. 2 is a perspective view of the star wheel feeder shown in FIG. 1 having a first embodiment; and

FIG. 3 is a perspective view of the star wheel feeder shown in FIG. 1 having a second embodiment.

A glass container inspection machine includes a star wheel feeder assembly 10 which is rotatively driven in clockwise angular steps to remove bottles 12 from a linear conveyor 14 (as shown the conveyor is carrying bottles right to left), incrementally displace these bottles along an annular support 15 to a series of inspection stations 16, and then replace the inspected bottles on the linear conveyor.

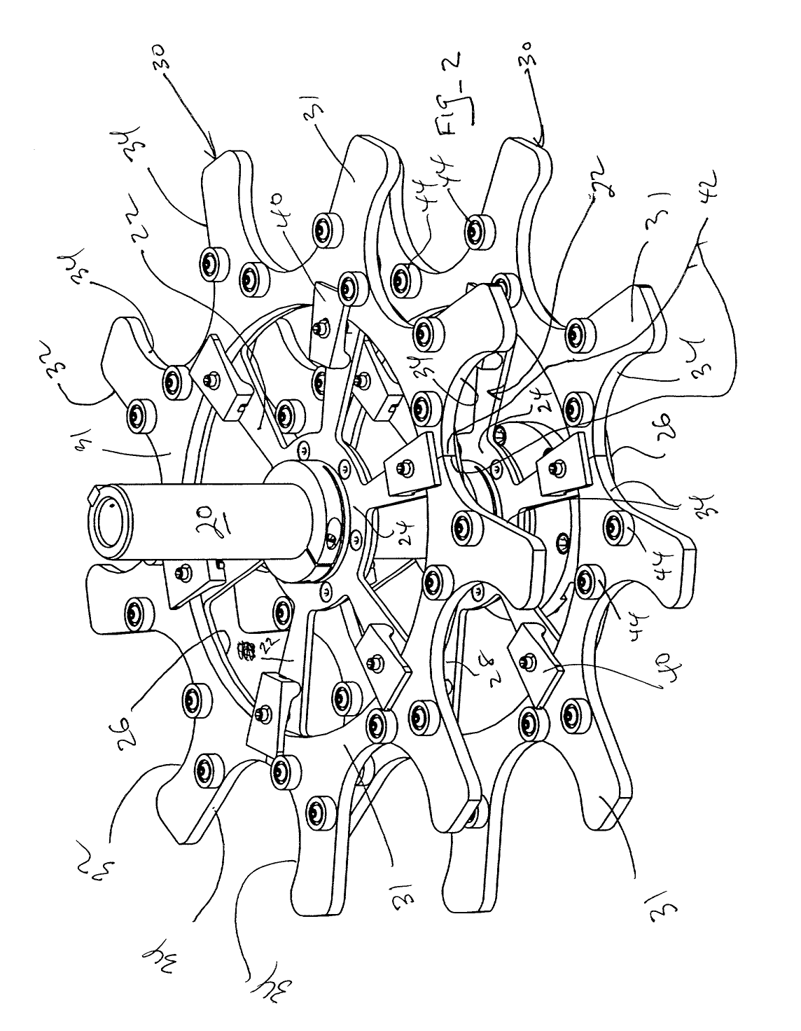

A nine-pocket star wheel assembly (FIG. 2) includes a central vertical shaft 20, which is rotatively driven by a servomotor (not shown). To this shaft are releasably secured upper and lower mounting wheels 22 which are made up of a central hub portion 24, which can be releasably clamped to the shaft at a desired height and orientation, an outer annular supporting ring portion 26 and a number (6) of spokes 28 which connect the central hub portion to the outer supporting ring portion. Located on the supporting ring portion 26 is an annular bottle carrier 30 which is made up of three identical segments 31. Each segment has two full bottle receiving pockets 32 and two half bottle receiving pockets 34 which with a half pocket of an adjacent segment will define an additional pocket. Releasable clamps 40, which are secured to the spokes 28, secure the annular bottle carrier 30 to the outer supporting ring portion. The three segments are located so that three of the releasable clamps 40 will clamp opposing ends 42 of adjacent segments to the outer support ring portion. In this configuration, large bottles are being inspected and both the upper and lower pockets will be located around the main body of the bottles with rollers 44 engaging the bottles.

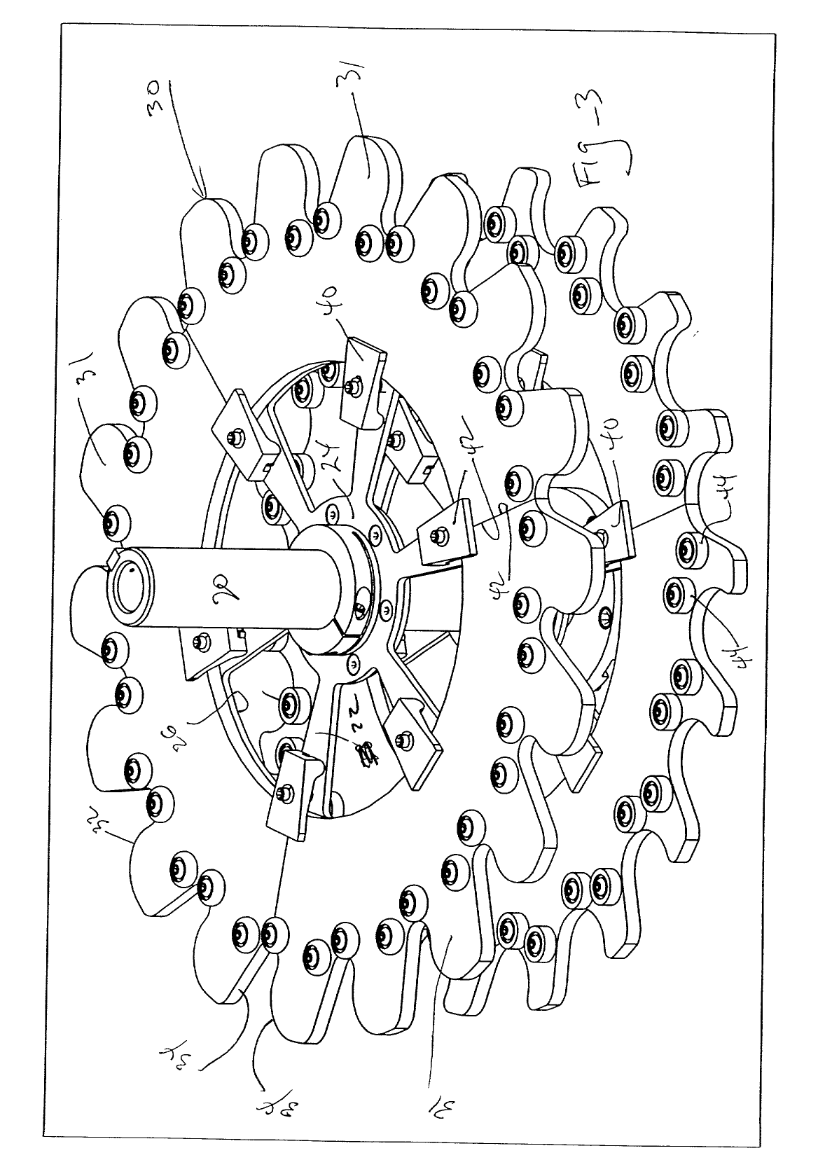

An eighteen-pocket star wheel assembly (FIG. 3) includes the same central vertical shaft 20 and the same upper and lower mounting wheels 22. Located on the supporting ring portion 26 is an annular bottle carrier 30 which is made up of three identical segments 31. Each segment has five full bottle receiving pockets 32 and two half bottle receiving pockets 34 which with a half pocket of an adjacent segment will define an additional pocket. The three segments are located so that three of the releasable clamps 40 will clamp opposing ends 42 of adjacent segments to the outer support ring portion proximate the pocket. In this configuration, small bottles are being inspected and the upper pockets will be located around the neck portion of a bottle and the lower pockets will be located around the main body of the bottles with rollers 44 engaging the bottles.

As can be seen, whether the star wheels are carrying large or small bottles, a half pocket at the end of one segment will form a pocket with a half pocket at the end of an adjacent segment and these segments will be clamped to the annular supporting ring portion 26 on either side of the adjacent segment surfaces by clamps 40 which will clamp proximate the edge of the pocket.

The following advantages of this system are: 1. the parting line 42 does not occur on the finger area between pockets 32 which would weaken the finger area; 2. The ware specific elements 31 can be quickly released by loosening the clamps 40 and having three segments, they are smaller and easier to remove from the annular supporting ring portion 26; 3. because the segments are smaller and supported by hub 22,24,26,28, they can be machined from smaller stock making them easier to machine with less material wasted.

1. A glass container inspection machine comprising a star wheel carrier assembly including
a vertical rotatable shaft,
upper and lower hub assemblies mounted on said vertical rotatable shaft each having
a central hub portion including fastener means for securing said central hub portion on said vertical rotatable shaft, and
an annular outer supporting portion,
three identical carrier segments arranged in side by side relation to form an annular carrier, each having a plurality of bottle receiving pockets and a partial pocket at either end thereof which, with a partial pocket of an adjacent segment forms a complete bottle receiving pocket, and
releasable fastener means for securing said three identical carrier segments on said annular outer supporting portion.

2. A glass container inspection machine according to claim 1, wherein said releasable fastener means comprises clamping means and wherein there are at least three clamping means each selectively located to engage adjacent segments proximate the pocket formed by said segments.

3. A glass container inspection machine according to claim 1, wherein said upper and lower hub assemblies each further comprise a plurality of spokes for interconnecting said central hub portion and said
annular outer supporting portion.

4. A glass container inspection machine according to claim 1, wherein each of said segments consists of two full pockets.

5. A glass container inspection machine according to claim 1, wherein each of said segments consists of five full pockets.
